(19) United States
(12) Patent Application Publication
(10) Pub. No.: US 2007/0244864 A1
(43) Pub. Date: Oct. 18, 2007

(54) Modifying thresholds for communications traffic data

(75) Inventor: Matthew Musko, Decatur, GA (US)

Correspondence Address: MERCHANT & GOULD PC, P.O. BOX 2903, MINNEAPOLIS, MN, 55402-0903, US

(73) Assignee: BellSouth Intellectual Property Corporation

(21) Appl. No.: 11/406,159

(22) Filed: Apr. 18, 2006

(51) Int. Cl. G06F 17/30

(52) U.S. Cl. 707/3

(57) ABSTRACT

Methods, systems, and computer program products modify one or more thresholds used to monitor communications traffic data. A method involves identifying threshold register keywords associated with thresholds to be modified. The threshold register keywords identify thresholds within threshold tables used to monitor the communications traffic. The method further involves examining each threshold table for the threshold register keywords identified for modification and modifying one or more threshold registers associated with the threshold register keywords identified for modification. Modifying the threshold registers includes deleting from, changing within, and/or adding to the threshold tables, the identified threshold register keywords and/or associated data.

### COPYRIGHT NOTICE

A portion of the disclosure of this patent document contains material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### BACKGROUND

Traffic Data Management Systems (TDMSs) for communications networks maintain a threshold table for every network element, for example voice switch, provisioned via that TDMS. Network Assistants use the TDMS to perform routine database cleanup or modifications to threshold tables. A threshold file or table is a reference table that is compared to raw metric data coming from the voice switches and/or network elements. This metric data provides numerous statistical values associated with the voice switches. Values that exceed threshold parameters of a particular metric are flagged so that the appropriate parties can be notified. The routine nature of threshold modification, such as threshold database cleanup, is very time consuming and has been known to affect the performance of the TDMS due to the inefficient methods of how the backend code for conventional TDMSs, for instance UNIX shell graphical user interface (GUI), is written.

Each threshold table is assigned to a network element, for instance a voice switch and each statistic that can be monitored or measured in association with a network element is assigned a threshold register keyword. The threshold register keyword is a distinct index identifier for a particular statistic, such as the quantity of overflow calls beyond a threshold to telephone numbers associated with a particular voice switch.

### BRIEF DESCRIPTION OF THE DRAWINGS

FIG. 1 illustrates an illustrative operating environment and computing system;

FIG. 2 illustrates a subset of a switch's threshold table before modifying the threshold data associated with identified threshold register keywords;

FIG. 3 illustrates the threshold table of FIG. 2 after modifying the threshold data associated with the identified threshold register keywords;

FIG. 4 is an illustrative routine performed in modifying one or more thresholds used to monitor communications traffic data; and

FIG. 5 illustrates a segment of a diagnostic table displaying recorded deletion modification instances.

### DETAILED DESCRIPTION

As briefly described above, embodiments of the present invention modify thresholds used to monitor communications traffic data associated with communications network elements or components, such as voice switches at a central office. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

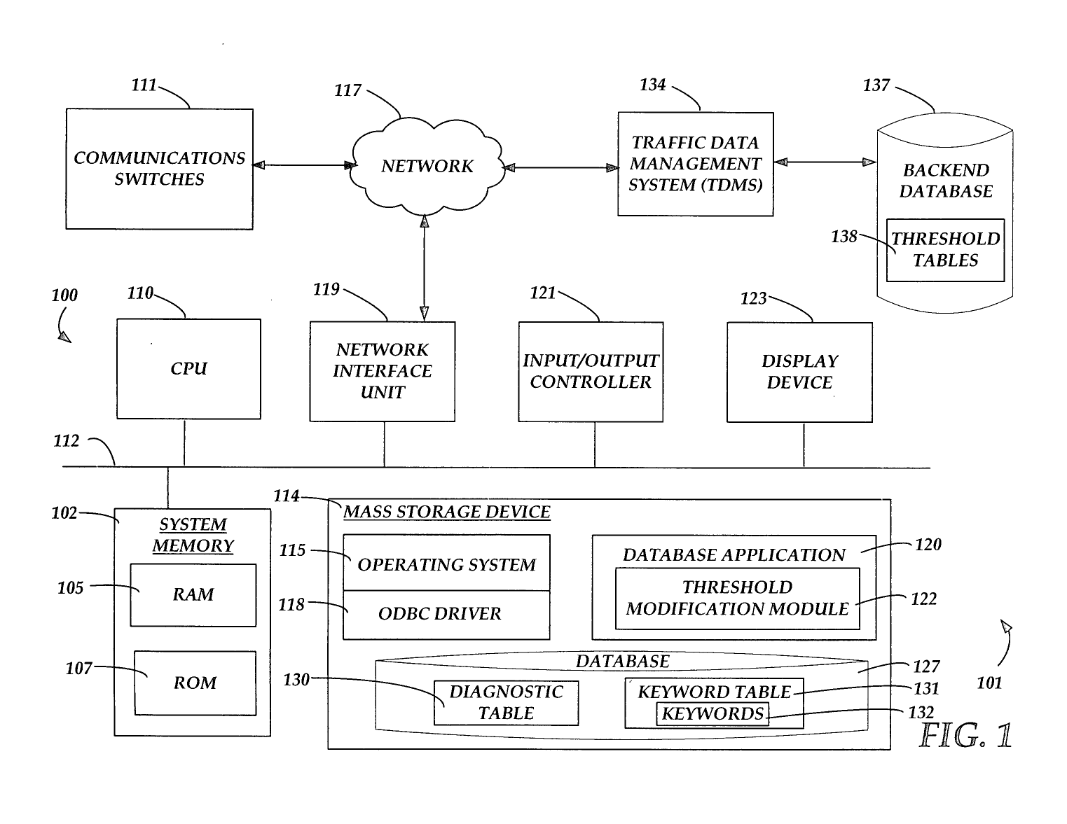

Referring now to the drawings, in which like numerals refer to like elements through the several figures, aspects of the present invention and an exemplary computing operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal or server computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary operating environment 101 for implementing an embodiment of the invention includes a computing apparatus, such as computing apparatus 100, a TDMS 134, and communications switches 111 in communication via a network 117. In a basic configuration, the computing apparatus 100 typically includes at least one processing unit 110, system memory 102, and a mass storage device (MSD) 114. Depending on the exact configuration and type of computing device, the system memory 102 may be volatile (such as RAM 105), non-volatile (such as ROM 107, flash memory, etc.) or some combination of the two. The MSD 114 typically includes an operating system 115 suitable for controlling the operation of a networked personal or server computer, such as the WINDOWS® operating systems from MICROSOFT CORPORATION of Redmond, Wash. or the UNIX operating system. The MSD 114 also includes a database application 120 such as ACCESS from MICROSOFT CORPORATION, an open database connectivity driver (ODBC) 118, and a database 127. The database 127 includes a diagnostic table 130 and threshold register keywords 132 identified for modification.

The database application 120 includes a threshold modification module (TMM) 122 providing for quick mass deletes, inserts, or changes to numerous, for instance hundreds, of threshold tables across one or more separate databases. The TMM 122 may be written in Visual Basic for Applications (VBA). VBA is a language that allows a programmer to “hook” into the functionality of applications such as OFFICE from MICROSOFT CORPORATION of Redmond, Wash. OFFICE includes WORD, EXCEL, ACCESS, OUTLOOK, and VISIO from MICROSOFT CORPORATION. The TDMS 134 uses one or more backend databases 137, such as an INFORMIX database from IBM Corporation of White Plains, N.Y., running on a server that uses, for example, a SOLARIS UNIX operating system from SUN MICROSYSTEMS. The database 137 contains multiple threshold tables 138.

VBA code, such as the TMM 122, uses a technology called ActiveX Data Objects (ADO) to communicate with the TDMS Informix database 137. ADO is a code library that allows programmers to utilize the functionality of ODBC drivers provided by database vendors. Thus, the TMM 122 connects to the database 137 and connects to all relevant threshold tables 138 via the ODBC driver 118. The communications switches 111 report on thousands of individual metrics. Each metric is assigned a keyword. A group of metrics is grouped into a section and assigned a number. Switch Administrators identify which metrics are important enough to create a threshold value.

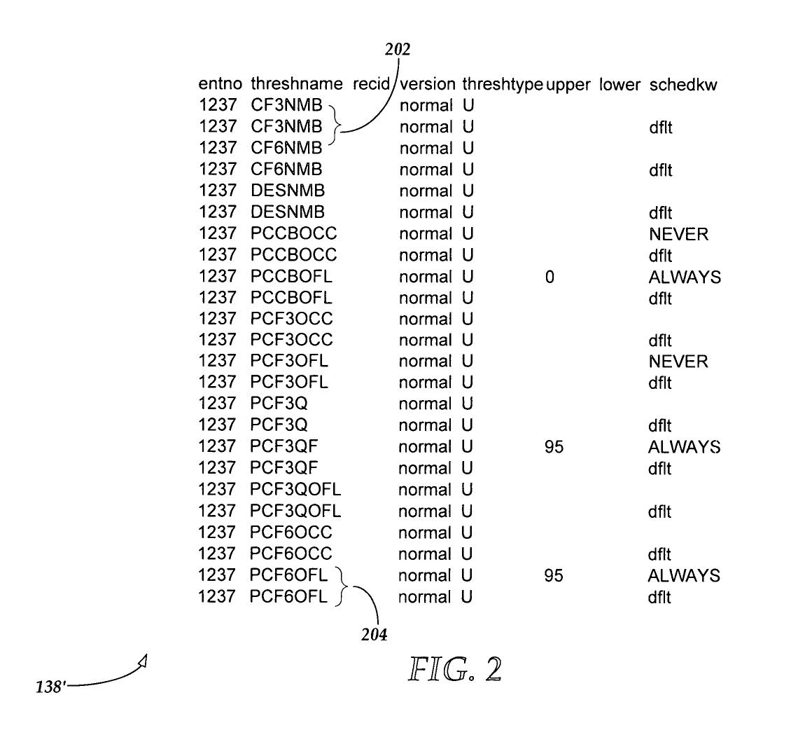

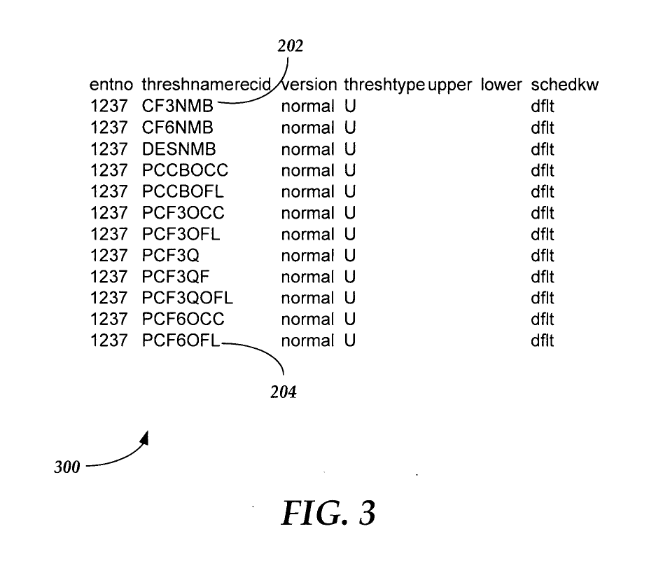

Thus, when a Network Assistant uses the TDMS 134 application, they enter the threshold table for every individual communications switch 111. Because keywords are assignable by threshold registers, many threshold keywords of the same name may exist in any given threshold table 138. The TMM 122 removes unwanted keyword registers and inserts one record with the keyword assigned to a default register, such as register 0. Register 0 is a place holder that is added to the TDMS 134 when threshold register keywords 132 are added to a communications switch 111. The TMM 122 can also add threshold register keywords 132. Additional details with respect to threshold register keywords and threshold registers will be described below with respect to FIGS. 2 and 3.

According to embodiments of the present invention, FIGS. 1-4 are illustrative of the database application 120 working in conjunction with the TMM 122 and the ODBC driver 118 to manipulate data within the backend database 137 by accessing one or more remote servers and treating the data as its own. The TMM 122 creates links to the threshold tables 138 on the backend database 137 using the ODBC driver 118. The ODBC driver 118 allows different databases or end users to communicate using a common functionality.

The TMM 122 programmatically links to the database tables 138 that contain threshold values for each switch 111. For instance, the TMM 122 may accept a standardized list of threshold values that need to be removed from each switch type and loops through each table 130, deleting the threshold registers. Example switch vendors, who make 6 major switch models supporting the operating environment, 101 include LUCENT 1A/5E, SIEMENS EWSD/DCO, and NORTEL 10/100.

The MSD 114 is connected to the CPU 110 through a mass storage controller (not shown) connected to the system bus 112. The MSD 114 and its associated computer-readable media, provide non-volatile storage for the computing apparatus 100. Although the description of computer-readable media contained herein refers to a MSD, such as a hard disk or RAID array, it should be appreciated by those skilled in the art that computer-readable media can be any available media that can be accessed by the CPU 110.

The CPU 110 may store data to and access data from the MSD 114. Data is transferred to and received from the MSD 114 through the system bus 112. The CPU 110 may be a general-purpose computer processor. Furthermore, as mentioned below, the CPU 110, in addition to being a general-purpose programmable processor, may be firmware, hard-wired logic, analog circuitry, other special purpose circuitry, or any combination thereof.

According to various embodiments of the invention, the computing apparatus 100 can operate in a networked environment, as shown in FIG. 1, using logical connections to remote computing devices via network communication, such as an Intranet, or a local area network (LAN). The computing apparatus 100 may connect to the network 117 via a network interface unit 119. It should be appreciated that the network interface unit 119 may also be utilized to connect to other types of networks and remote computer systems. The computing apparatus 100 also includes an input/output controller 121 for receiving and processing input from a number of devices, including a keyboard (not shown). Similarly, the input/output controller 121 provides output to a display screen 123, a printer, or other type of output device.

A computing device, such as the computing apparatus 100, typically includes at least some form of computer-readable media. Computer readable media can be any available media that can be accessed by the computing apparatus 100. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the computing device 100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

FIG. 2 illustrates a subset of a switch's threshold table 138′ before modifying the threshold data associated with threshold register keywords identified for deletion, addition, or changes according to an embodiment of the present invention. This shows a subset of a switch's threshold file before the ‘threshold modification’ scripts are run. In this example, a work center responsible for updates to the threshold tables 130 is asked to remove 12 distinct keywords represented in the data set in threshold table 138′. The threshold table 138′ includes a keyword, such as the keywords 202 and 204, for each threshold register. Each register also includes fields for an upper and a lower threshold setting as well as a default (dflt) register, for example register 0, associated with each threshold keyword.

Each threshold register contains rules that belong to at least one of the communications switches 111. Each register also contains the same parameters including an entity number associated with the pertinent switch 111. Thus, each switch 111 and associated threshold(s) is represented in the threshold files or tables 138 and there is one threshold register for every switch 111 in the network associated with the TDMS 134. Each voice switch 111 has modules, they are basically line cards and each line card can support so many customers. Thus, one switch 111 may have hundreds of line cards or modules in that switch and each module actually reports a statistic.

FIG. 3 illustrates the subset of threshold table 138′ after modifying the threshold data associated with the threshold register keywords identified for revisions according to an embodiment of the present invention. The TMM 122 removes all entries and inserts a default (dflt) record for each keyword 132. This allows for later additions of that keyword 132 should threshold monitoring associated with that addition be required. As illustrated, the twelve keywords presented in FIG. 2 are present as default registers. However, in this case the registers have been deleted from the table 138′ and replaced with the dflt registers for future reference.

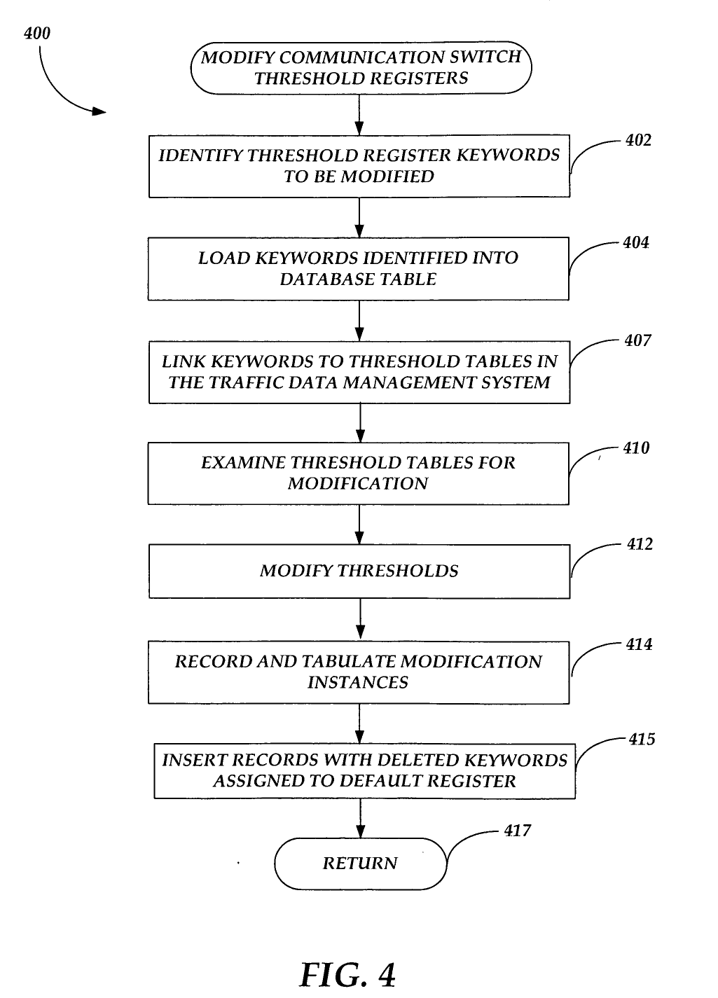

FIG. 4 is an illustrative logical flow routine 400 performed in modifying one or more thresholds used to monitor communications traffic data according to an embodiment of the present invention. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIG. 4, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

Referring now to FIGS. 1-4, the logical flow routine 400 begins at operation 402, where the TMM 122 identifies threshold register keywords associated with thresholds that are or need to be modified, for example deleted. For instance, the TMM 122 may receive the keywords that need deleting via administrator input. The threshold register keywords 132 identify thresholds within threshold tables 130 used to monitor the communications traffic. Next, at operation 404 the TMM 122 loads the threshold register keywords 132 identified into a database keyword table 131.

Next the logical flow routine 400 continues to operation 407 where the TMM 122 links the keywords 132 to the threshold tables 138 in the TDMS 134. Then at operation 410, the TMM 122 examines each threshold table 138 to reference the threshold register keywords 132 identified for modification. The TMM 122 goes to the database 137 and looks for all tables 138 that are identified in the table name for threshold. The TMM 122 looks for anything that has ‘THRES’ in the table names so the associated tables will be the only tables 138 that the TMM 122 manipulates. Even if an administrator is currently logged in as owner of the same table for manual modifications, the TMM 122 compensates by dropping the link and re-linking as the new computer control unit (CCU) owner thereby avoiding a crash.

At operation 412, the TMM 122 modifies the threshold registers in the threshold tables 138 associated with the threshold register keywords 132 identified for modification. For instance, the TMM 122 may delete the threshold registers associated with the keywords 132 identified for deletion.

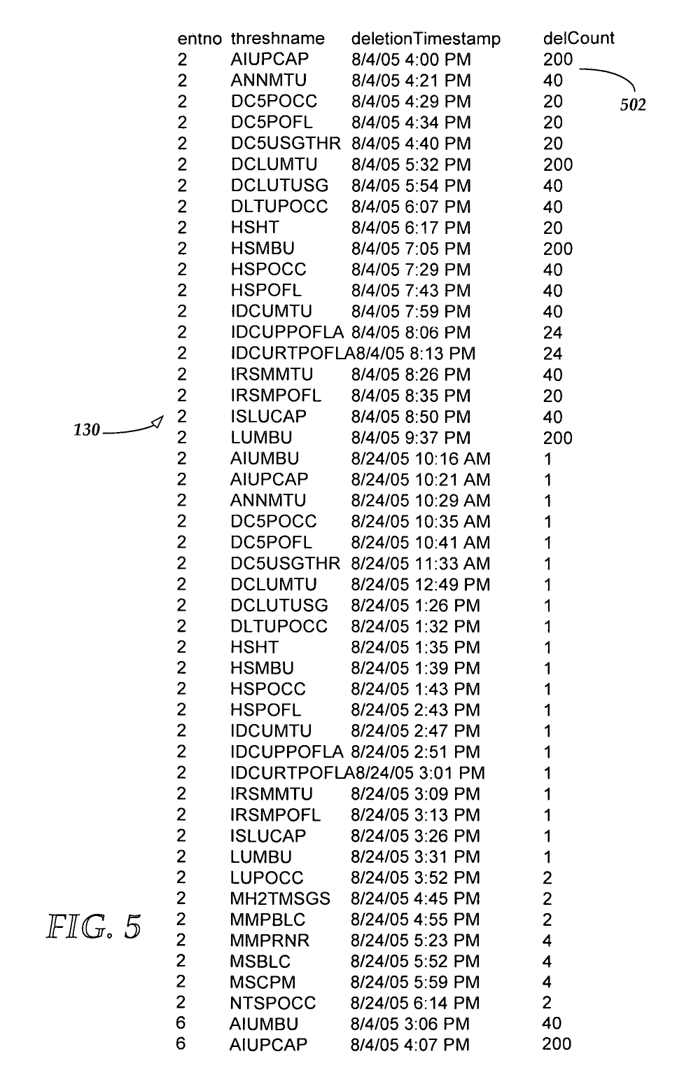

Next at operation 414, the TMM 122 records and/or tabulates modification instances based on modifications to the threshold registers. Additional details regarding this tabulation will be described below with respect to FIG. 5. The TMM 122 then inserts a record for each threshold register keyword deleted at operation 415. Each threshold register keyword deleted is assigned to a default register, such as register zero (0). In the alternative, the TMM 122 can only delete threshold registers not equal to zero. This creates or maintains a placeholder for adding back the deleted keyword in the future. The entry number 0, which is a default, keeps the keyword in the system. For instance, if a line module is associated with subscripts 1 through 100, there will actually be 101 registers built. The first 100, 1 through 100, are actually associated with the line module and the 0 is just a placeholder.

The logical flow 400 routine then returns control to other routines at return operation 417. It should be appreciated that the present invention is not limited to modifying one or more threshold registers associated with voice switches. Embodiments of the present invention may be used to modify threshold values used in monitoring communications traffic to and from a text messaging center. The TMM 122 can update any threshold table associated with devices being monitored by the TDMS 134. When a text messaging center, is being monitored by the TDMS 134 and is assigned an entity number in the TDMS, then the TMM 122 updates any associated threshold values pertaining to the text messaging center.

Also, instead of a deletion modification, the TMM 122 can process a change to the thresholds. For example, when thresholds are reported in percentages the upper and lower thresholds can be as low as zero and as high as 100. So if administrators want to make sure that customers are not blocking or are not getting a fast busy signal more than 99% of the time, they may request a threshold change to assure customers always get service. For instance, the threshold can be modified such that anything over 95% is triggered to see if there are different things needed as far as putting up more capacity. Thus, the TMM 122 can make a change by modifying thresholds for the associated keyword to change the upper threshold to 95. A change writes over the previous value, thus the TMM 122 loops to wherever the keyword is equal to the identified keyword in order to change the upper threshold to 95%. Then anything that is already populated in that upper threshold would just be changed with the new number. Thus, even if there is just one module or 5000 modules associated with that keyword, a change is made on all or fewer modules that currently exist no matter how many are out there.

FIG. 5 illustrates a segment of the diagnostic table 130 displaying recorded deletion modification instances. As the TMM 122 runs, a status log is generated that counts how many records were deleted per keyword. The sample data provided in this diagnostic table is independent of the sample data provided in FIGS. 2-3. The data provided in the FIG. 5 is a report containing data from prior script runs. A first line 502 of the report represents that 200 records associated with keyword AIUPCAP on switch number 2 (entity 2) were deleted on 8/4/2005 at 4:00 PM. Therefore, before this deletion took place, there were threshold records built for 200 modules of entity number 2 switch checking for threshold values associated with the AIUPCAP keyword. This illustrates that the TMM 122 can make rapid modifications without manual human intervention. The TMM 122 keeps an inventory of which table that it is currently modifying and last modified. For instance if there are 1000 threshold tables that need to be changed and somewhere around the 600^{th} table the network dropped, the TMM 122 can pick up where it left off.

Thus, the present invention is presently embodied as methods, systems, computer program products or computer readable mediums encoding computer programs for modifying one or more thresholds used to monitor communications traffic data.

It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

We claim:

1. A computer-implemented method for modifying a threshold used to monitor communications traffic data, the method comprising:
identifying a threshold register keyword associated with the threshold to be modified wherein the threshold register keyword identifies the threshold within threshold tables used to monitor the communications traffic;
examining each threshold table for the threshold register keyword identified for modification; and
modifying threshold registers associated with the threshold register keyword identified for modification.

2. The method of claim 1, prior to examining each threshold table further comprising:
loading the threshold register keyword identified into a database table; and
linking to the threshold tables containing the threshold registers.

3. The method of claim 1, further comprising tabulating modification instances based on modifications to the threshold registers.

4. The method of claim 1, wherein modifying the threshold registers comprises deleting from each threshold table the threshold register keywords identified for modification.

5. The method of claim 4, further comprising inserting a record for each threshold register keyword deleted wherein each threshold register keyword deleted is assigned to a default register therein creating a placeholder for adding the deleted keyword in the future.

6. The method of claim 1, wherein modifying the threshold registers comprises changing in each threshold table thresholds associated with the threshold register keywords identified for modification.

7. The method of claim 1, wherein modifying the threshold registers comprises adding to each threshold table that includes the threshold register keywords, the threshold register keywords identified for modification and associated thresholds.

8. The method of claim 1, wherein modifying the threshold registers comprises modifying threshold values used in monitoring communications traffic to and from voice communications switches.

9. The method of claim 1, wherein modifying the threshold registers comprises modifying threshold values used in monitoring communications traffic to and from a text messaging center.

10. A computer program product comprising a computer-readable medium having control logic stored therein for causing a computer to delete a threshold register used to monitor communications traffic data associated with a communications component, the control logic comprising computer-readable program code for causing the computer to:
identify a threshold register keyword associated with the threshold register to be deleted wherein the threshold register keyword identifies threshold values within threshold tables used to monitor the communications traffic;
examine each threshold table for the threshold register keyword identified for deletion; and
delete the threshold register associated with the threshold register keyword identified for deletion.

11. The computer program product of claim 10, prior to examining each threshold table further comprising computer-readable program code for causing the computer to:
load the threshold register keyword identified into a database table;
link to the threshold tables containing threshold registers.

12. The computer program product of claim 10, further comprising computer-readable program code for causing the computer to record modification instances based on deletion of the threshold registers.

13. The computer program product of claim 10, further comprising computer-readable program code for causing the computer to insert a record for each threshold register keyword deleted wherein each threshold register keyword deleted is assigned to a default register.

14. The computer program product of claim 10, wherein the communications component comprises a voice communications switch.

15. The computer program product of claim 10, wherein the communications component comprises a text messaging central server.

16. The computer program product of claim 13, wherein the computer-readable program code for causing the computer to record modification instances based on deletion of the threshold registers further causes the computer to record a time stamp and quantity associated with deletion of the threshold registers.

17. A computer-implemented system for modifying one or more thresholds used to monitor communications traffic data to and from voice communications switches, the system comprising:
means for receiving threshold register keywords associated with threshold registers to be modified wherein the threshold register keywords identify threshold values within threshold tables residing within a traffic data management system used to monitor the communications traffic;
means for loading the threshold register keywords into a database table;
means for linking to the threshold tables containing threshold registers;
means for examining each threshold table for the threshold register keywords received; and
means for modifying one or more threshold registers associated with the threshold register keywords received.

18. The system of claim 17, further comprising means for recording in a diagnostic table, modification instances based on a time of and quantity of modifications to the threshold registers.

19. The system of claim 17, further comprising means for inserting a record for each threshold register keyword modified therein assigning each threshold register keyword deleted to a default register.

20. The system of claim 17, further comprising means for displaying the diagnostic table or the threshold tables.
